(19) United States
(12) Patent Application Publication
(10) Pub. No.: US 2019/0240866 A1
(43) Pub. Date: Aug. 8, 2019

(54) DOSING MODULE

(71) Applicant: KRAUSSMAFFEI TECHNOLOGIES GMBH, München Bayern (DE)

(72) Inventor: Markus Agerer, Olching Bayern (DE)

(21) Appl. No.: 16/339,558

(22) PCT Filed: Oct. 19, 2017
(86) PCT No.: PCT/EP2017/076665

§ 371 Date: Apr. 4, 2019

(30) Foreign Application Priority Data
Nov. 2, 2016 (DE) 10 2016 120 872.8

(51) Int. Cl. B29B 7/32; B29B 7/60; B29B 7/80

(52) U.S. Cl. CPC B29B 7/325; B29B 7/94; B29B 7/801; B29B 7/60

(57) ABSTRACT

A dosing module (10) for dosing an auxiliary liquid into a flow of a main liquid, comprising: a housing (12) with an inlet port (14) and an outlet port (18) and with a flow duct (16), formed in between, for the main liquid, an auxiliary port (22) which is provided in the housing (12) and which serves for the supply of the auxiliary liquid into the flow duct, a mixing device (20) which is provided in a mixing section (16B) of the flow duct and which serves for mixing the main liquid and the auxiliary liquid, characterized in that the dosing module furthermore comprises: a bypass section (16C) for conducting the flow of main liquid to the outlet port so as to bypass the mixing device, and a directional valve (24, 25; 42; 44, 48; 52) which is designed to connect the outlet port, in a dosing position, to the mixing section and, in a bypass position, to the bypass section.

The present invention relates to a dosing module for dosing an auxiliary liquid into a flow of a main liquid, comprising:
a housing with an inlet port and an outlet port and with a flow duct, formed in between for the main liquid;
an auxiliary port which is provided in the housing and which serves for the supply of the auxiliary liquid into the flow duct; and
a mixing device which is provided in a missing section of the flow duct and which serves for mixing the main liquid and the auxiliary liquid.

Such dosing modules are used e.g. in liquid resin press moulding or in resin transfer moulding (RTM), in order to dose to the resin as main liquid a releasing agent as auxiliary liquid. In such RTM methods or HP-RTM methods (high pressure RTM), this concerns methods for the production of fibre-reinforced components. For this, fibre mats with e.g. carbon- or glass fibres are inserted into a tool and subsequently in a press under pressure are impregnated with a liquid mixture of resin and a hardener, and hardened. Hereby, extremely light structural components are obtained, which meet the highest requirements, for example in vehicle manufacturing, in the aviation and aerospace industry or in machine construction.

As main liquid, e.g. an epoxy resin is used which, coming from a resin rank, is supplied to the dosing module via the inlet port. In order to be able to remove the component easily and completely from the tool at the end of the production process, a suitable releasing agent is dosed to the resin in the dosing module via an auxiliary port. The resin as main liquid and the releasing agent as auxiliary liquid are then mixed with one another in a mixing device. The mixture leaves the dosing module through the outlet port and enters into a mixing head, where the further mixing with the hardener takes place.

Between two so-called shots, i.e. injections of the mixture of resin and hardener into the tool, modern liquid resin press moulding- or RTM systems provide a recirculation of the resin, in order to keep the pressure in the resin circuit substantially at a constant high level. Here, however, the problem arises that the resin tank is contaminated with releasing agent during the recirculation, which still adheres in the mixing device from the preceding shot. If one wishes to prevent such a contamination of the resin tank, the mixing device must be flushed with clean resin before the end of a shot, e.g. by closing the auxiliary port with a needle nozzle or other closure device. However, this has the consequence that in the discharged mixture at the end of a shot, as well as at the start of the following shot, releasing agent is not present, or at least is not present in a sufficient amount. The risk therefore exists that the produced component can not be demoulded cleanly from the tool.

It is therefore an object of the present invention to propose a dosing module in which a contamination of a main liquid tank with auxiliary liquid is also prevented in the recirculation of the main liquid.

This problem is solved according to the invention in a generic dosing module in that the dosing module furthermore comprises:
a bypass section for conducting the flow of main liquid to the outlet port so as to bypass the mixing device; and
a directional valve, which is designed to connect the outlet port, in a dosing position, to the mixing section and, in a bypass position, to the bypass section.

Immediately before a shot, the directional valve is brought into its dosing position. The mixture of main liquid, e.g. resin, and auxiliary liquid, e.g. releasing agent, can then flow through the mixing device and the directional valve to the outlet port.

On the other hand, with the end of a shot the directional valve is brought into its bypass position. The main liquid, e.g. resin, can then flow, bypassing the mixing device, to the outlet port. A contact of the resin with remaining releasing agent in mixing device is therefore prevented, and the resin can be recirculated to the resin tank without having to fear its lingering contamination with releasing agent.

In the case of this dosing module according to the invention, the bypass section can be formed in the housing or provided on the outer side of the housing, in particular as a pipeline.

For reasons of space, in the case of a liquid resin press moulding- or RTM system, the mixing device can expediently be a static mixer.

In a particularly space-saving preferred embodiment of the dosing module according to the invention, provision is made that the directional valve comprises a valve tappet in which the mixing device is arranged, wherein the valve tappet is movable in the housing between a dosing position, in which the flow of main liquid and the auxiliary liquid run through the valve tappet, and a bypass position, in which the valve tappet conducts the flow of main liquid into the bypass section and separates the auxiliary port from the flow duct.

A configuration is possible here, in which the valve tappet, in the bypass position, closes the auxiliary port.

A separate closure device for the auxiliary port is then not necessary.

Alternatively, the same aim can also be achieved in that the valve tappet is provided with a recirculation groove which, in the bypass position, connects the auxiliary port to an auxiliary liquid return duct provided in the housing. In this case, the auxiliary port is not closed, but rather also remains open in the bypass position of the valve tappet, however the auxiliary liquid does not flow into the flow duct, but rather through the recirculation groove back to an auxiliary liquid tank.

The valve tappet can be movable between the dosing position and the bypass position by a hydraulically and/or pneumatically and/or electrically driven sliding- and/or rotational movement.

In a particular embodiment, provision is made here that the valve tappet is designed for hydraulic displacement using the main liquid as hydraulic liquid. Therefore the need to provide separate lines and/or containers for a pneumatic and/or electric drive or for a hydraulic drive with a separate hydraulic liquid is largely dispensed with.

In a further development, this particular embodiment can comprise, furthermore, a return spring, which acts upon the valve tappet in the direction of the bypass position. Hereby, a particularly quick and reliable switching of the directional valve into its bypass position is made possible.

In a further development, the dosing module can comprise a direct inlet port for the direct letting in of main liquid into the bypass section. In this case, the main liquid, e.g. resin, therefore has at its disposal at least two different inflows to the dosing module according to the invention, wherein the inflow in the dosing position of the directional valve takes place through the normal inlet port which leads to the mixing section, whereas the inflow in the bypass position of the directional valve takes place through the direct inlet port directly into the bypass section.

In an alternative embodiment without a movable valve tappet, provision is made that the mixing device is integrated in a stationary manner in the mixing section of the flow duct, and that the directional valve comprises a ball cock valve, a non-return valve or a slide valve, which is provided downstream of the mixing device and is designed, in a dosing position, to conduct the flow of main liquid, intermixed with auxiliary liquid, to the outlet port, and, in a bypass position, to conduct the flow of main liquid out from the bypass section to the outlet port. Such a ball cock-, non-return- or slide valve can be driven electrically and/or pneumatically and/or hydraulically.

In particular, the directional valve can comprise respectively a non-return valve associated with the mixing section or respectively with the bypass section, wherein preferably at least one of the non-return valves comprises a ball with an associated seal seat.

As already explained above, the dosing module according to the invention is particularly suitable for liquid resin press moulding or respectively RTM- or HP-RTM systems, in which the main liquid contains a resin and/or the auxiliary liquid contains a releasing agent. However, the dosing module according to the invention is also suitable for other applications, for example systems in which the main liquid and/or the auxiliary liquid contain different dyes, lacquers and/or glazes.

Embodiments of the invention are explained below with the aid of the figures as non-restrictive examples. Herein there are shown:

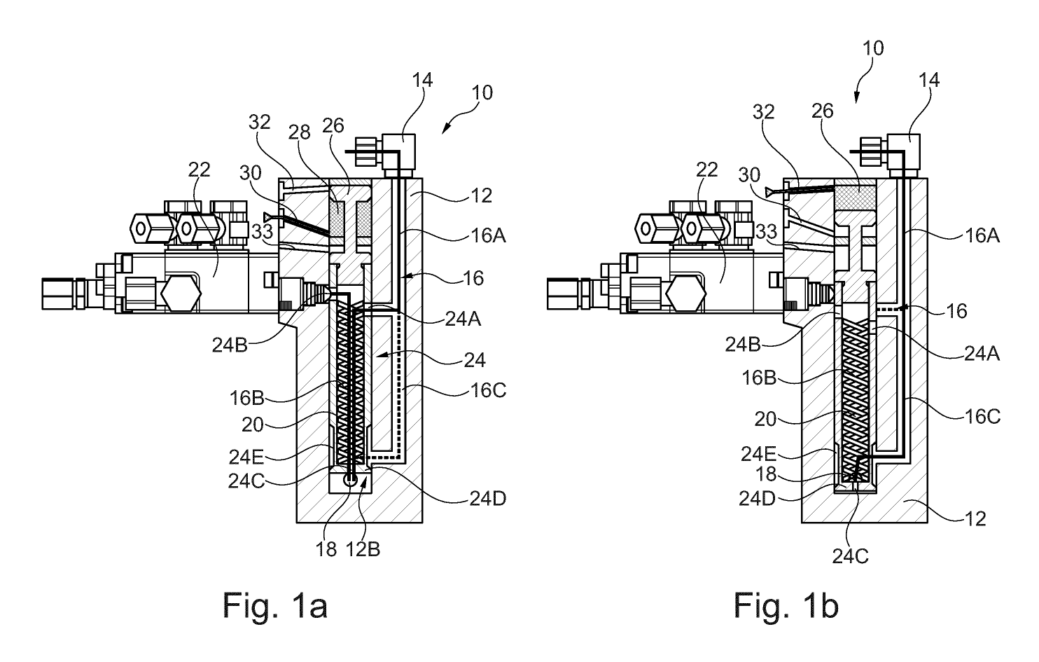

FIG. 1a a diagrammatic sectional view of a first embodiment of the dosing module according to the invention, in the dosing position;

FIG. 1b a diagrammatic sectional view of the embodiment of FIG. 1a in the bypass position;

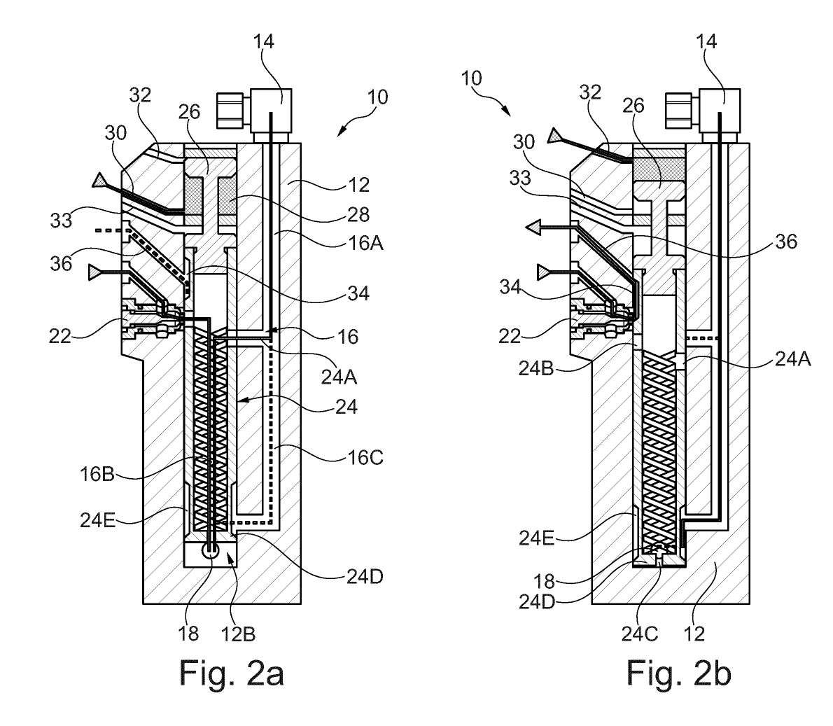

FIG. 2a a diagrammatic sectional view of a second embodiment of the dosing module according to the invention, in the dosing position;

FIG. 2b a diagrammatic sectional view of the embodiment of FIG. 2a in the bypass position;

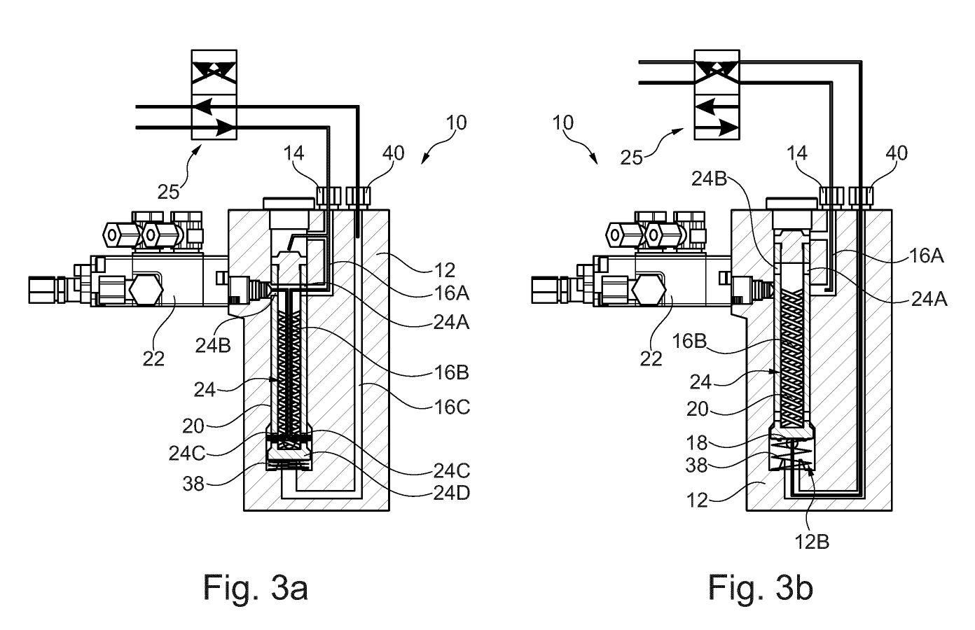

FIG. 3a a diagrammatic sectional view of a third embodiment of the dosing module according to the invention, in the dosing position;

FIG. 3b a diagrammatic sectional view of the embodiment of FIG. 3a in the bypass position;

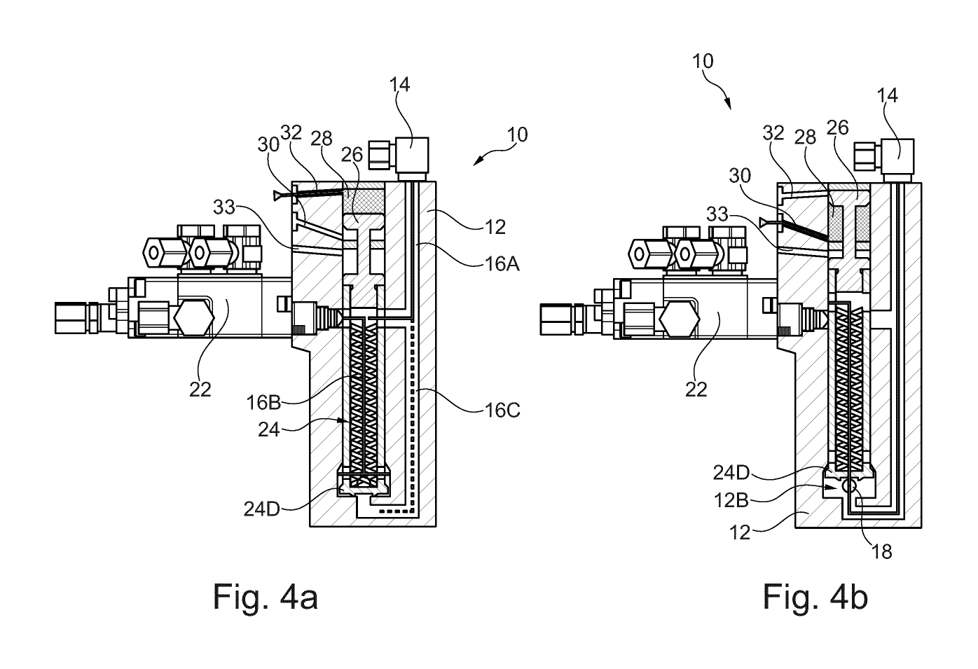

FIG. 4a a diagrammatic sectional view of a fourth embodiment of the dosing module according to the invention, in the dosing position;

FIG. 4b a diagrammatic sectional view of the embodiment of FIG. 4a in the bypass position;

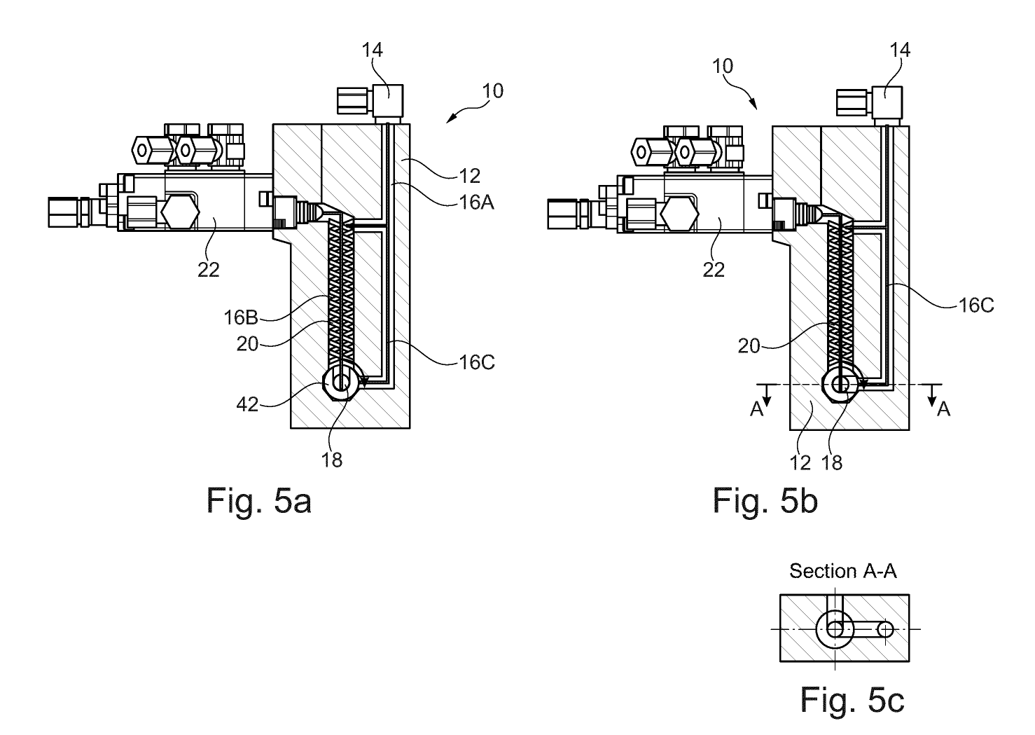

FIG. 5a a diagrammatic sectional view of a fifth embodiment of the dosing module according to the invention, in the dosing position;

FIG. 5b a diagrammatic sectional view of the embodiment of FIG. 5a in the bypass position;

FIG. 5c a diagrammatic sectional view of the ball cock valve used in the fifth embodiment, with a section along the plane A-A in FIG. 5b;

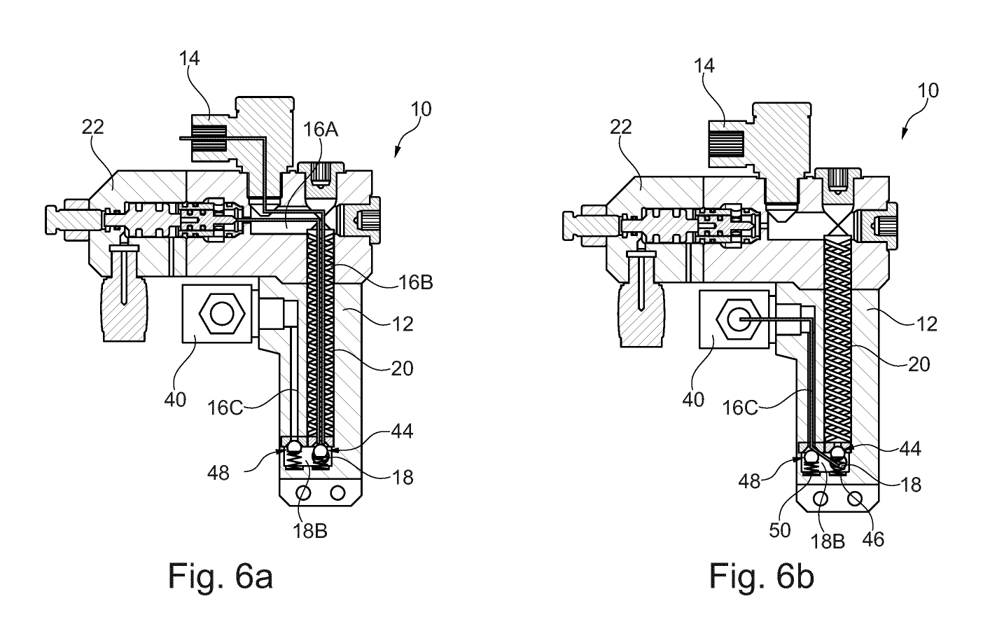

FIG. 6a a diagrammatic sectional view of a sixth embodiment of the dosing module according to the invention, in the dosing position;

FIG. 6b a diagrammatic sectional view of the embodiment of FIG. 6a in the bypass position;

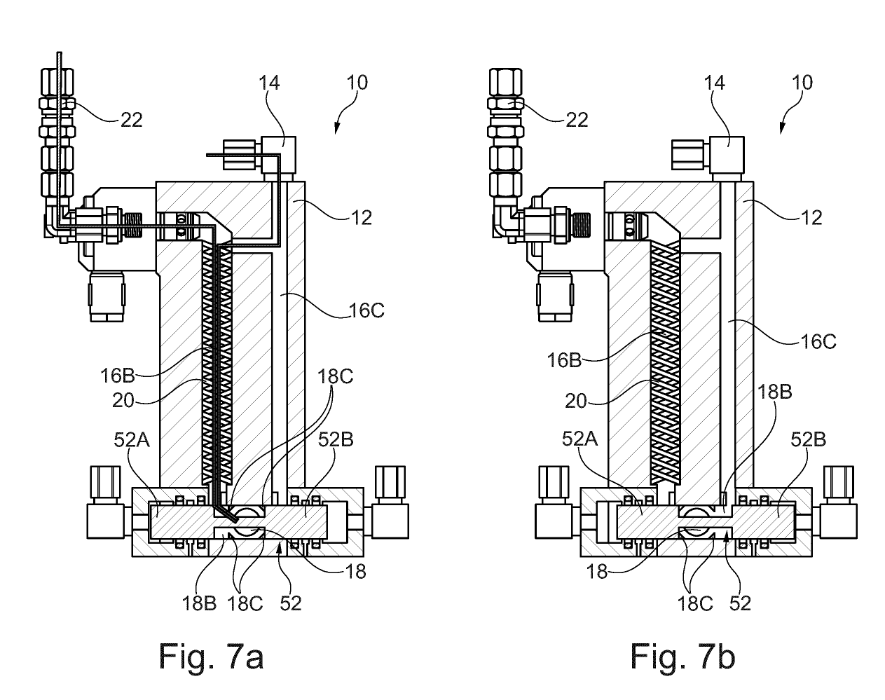

FIG. 7a a diagrammatic sectional view of a seventh embodiment of the dosing module according to the invention, in the dosing position;

FIG. 7b a diagrammatic sectional view of the embodiment of FIG. 7a in the bypass position;

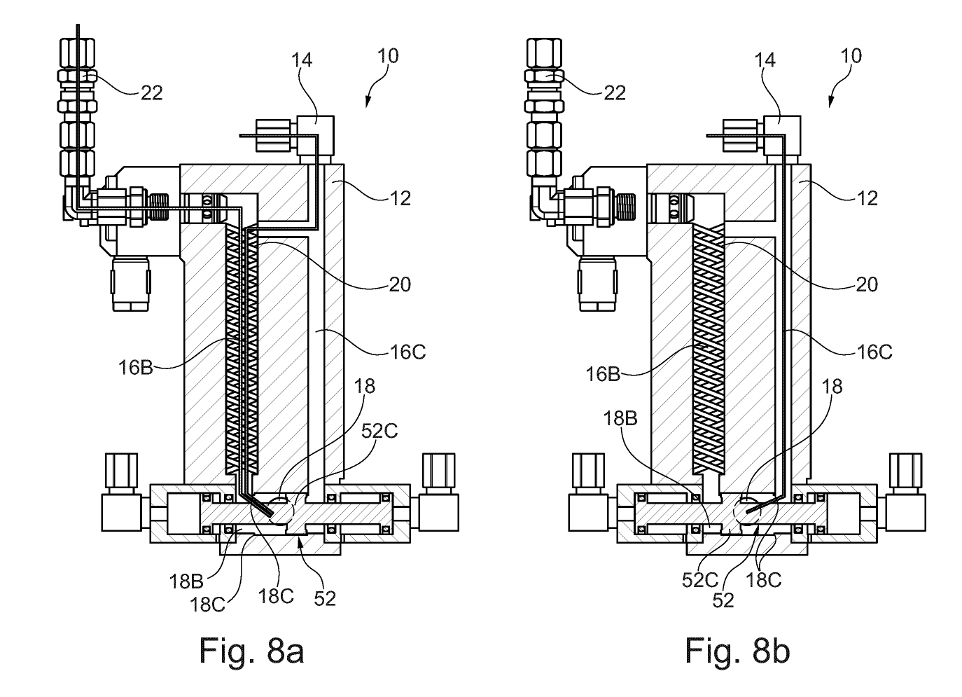

FIG. 8a a diagrammatic sectional view of an eighth embodiment of the dosing module according to the invention, in the dosing position; and

FIG. 8b a diagrammatic sectional view of the embodiment of FIG. 8a in the bypass position.

FIGS. 1a and 1b show diagrammatic cross-sectional views of a first embodiment of the dosing module 10 according to the invention in the dosing position or respectively in the bypass position. The dosing module 10 comprises a housing 12, which can be made in particular from metal, and on which in the figures at the top an inlet port 14 is provided for letting in a main liquid.

From the inlet port 14, the main liquid flows generally through a flow duct 18 to an outlet port 18 in the lower region of the housing 12 in the figures, and from there e.g. in the case of the use of the dosing module 10 according to the invention in an RTM system, further to a mixing head, where a mixing with a hardener takes place.

The flow channel 16 comprises, immediately downstream of the inlet port 14, a feed section 16A and, adjoining hereto, a mixing section 16B and a bypass section 16C parallel hereto. In the dosing position shown in FIG. 1a, the main liquid flows from the inlet port 14 through the feed section 16A and the mixing section 16B to the outlet port 18, in the bypass section shown in FIG. 1b, on the other hand, through the feed section 16A and the bypass section 16C to the outlet port 18.

In the dosing position, the main liquid mixes in a static mixer 20, which is arranged in the mixing section 16B, with an auxiliary liquid which is supplied into the flow duct 16 through an auxiliary port 22 provided on the housing 12. The static mixer 20 is arranged in a hydraulically driven valve tappet 24 which, in its dosing position shown in FIG. 1a, is situated substantially at its upper position in a main bore 12B in the housing 12, because a valve piston 26, connected to the valve tappet 24, is acted upon at its lower side in FIG. 1a with hydraulic fluid in a hydraulic chamber 28 arranged over the main bore 12B. For this, the hydraulic chamber 28 is connected in its lower region with a hydraulic bore 30. The supply of hydraulic fluid through the hydraulic bore 30 into the hydraulic chamber 28 is indicated diagrammatically in FIG. 1a by an arrow.

In the dosing position shown in FIG. 1a, a main liquid bore 24A provided in the wall of the valve tappet 24 frees the connection from the feed section 16A to the mixing section 16B, and an opposite auxiliary liquid bore 24B in the wall of the valve tappet 24 frees the connection from the auxiliary port 22 to the mixing section 16B, so that both types of liquids can arrive into the static mixer 20, from where, after their intermixing, they can flow out through a central outflow bore 24C at the lower end of the valve tappet 24 to the outlet port 18 provided at the bottom in the main bore 12B. At the same time, a sealing edge 24D running in circumferential direction at the lower end of the valve tappet 24 separates the downstream end of the bypass section 16C from the outlet port 18, so that no direct outflow of main liquid is possible through the bypass section 16C.

In order to move the valve tappet 24, starting from its dosing position shown in FIG. 1a, into the bypass position shown in FIG. 1b, the supply of hydraulic fluid through the hydraulic bore 30 into the lower region of the hydraulic chamber 28 is terminated and, instead, hydraulic fluid is supplied through a hydraulic bore 32 into the upper region of the hydraulic chamber 28, as is indicated diagrammatically by an arrow in FIG. 1b. Air can flow here through a bore 33, drawn in the figures, into an air space in the upper region of the main bore 12B. Hereby, the valve tappet 24 is moved downwards in the figures, so that its main liquid bore 24A and its auxiliary liquid bore 24B are no longer aligned suitably to the upstream region of the mixing section 16B or respectively to the main port 22. Rather, the wall of the valve tappet 24 above the main liquid bore 24A now closes the upstream region of the mixing section 16B, and its wall above the auxiliary liquid bore 24B closes the auxiliary port 22. Neither the main nor the auxiliary liquid can arrive at the static mixer 20 in this position of the valve tappet 24. At the same time, however, a radial groove 24E in the lower region of the valve tappet 24 immediately above its sealing edge 24D opens a passage for the main liquid from the bypass section 16C to the outlet port 18.

In this bypass position of the dosing module 10 according to the invention, the main liquid, e.g. resin, can flow to the outlet port 18, bypassing the mixing device. Meanwhile, the static mixer 20 is, as it were, short-circuited. A contact of the resin with remaining releasing agent in the static mixer 20 is therefore prevented, and the resin can be recirculated to the resin tank without having to fear its lingering contamination with releasing agent.

FIGS. 2a and 2b show a diagrammatic sectional view of a second embodiment of the dosing module 10 according to the invention, in the dosing position or respectively in the bypass position. The second embodiment differs from the first embodiment explained above substantially in that the valve tappet 24 has a recirculation groove 34 in its wall above the auxiliary liquid bore 24B, top left in FIGS. 2a and 2b. In the bypass position shown in FIG. 2b, this wall therefore does not close the auxiliary port 22. Rather, the auxiliary liquid can flow through the recirculation groove and an auxiliary liquid return duct 36 associated therewith in the housing 12 of the dosing module 10 according to the invention back to an auxiliary liquid tank, which is not illustrated. Therefore, between two shots, not only the main liquid, e.g. resin, but also the auxiliary liquid, e.g. releasing agent, can circulate in order in particular to guarantee a constantly high pressure and a uniform temperature distribution in the auxiliary liquid. This releasing agent circulation in the bypass position is indicated diagrammatically in FIG. 2b by arrows.

FIGS. 3a and 3b show a diagrammatic sectional view of a third embodiment of the dosing module 10 according to the invention, in the dosing position or respectively in the bypass position. In this third embodiment of the dosing module 10 according to the invention, the valve tappet 24 is designed for hydraulic displacement using the main liquid as hydraulic liquid. The hydraulic bores 30, 32 provided in the first embodiment, and associated hydraulic lines and a separate tank for a hydraulic liquid are therefore not necessary. Rather, in the third embodiment, a 4/2-way valve 25 is associated with the valve tappet 24, which valve is indicated diagrammatically in FIGS. 3a and 3b above the housing 12.

In the dosing position shown in FIG. 3a, the 4/2-way valve is switched such that the main liquid flows through the inlet port 14 and the upstream initial region of the feed section 16A into the housing 12 and then—similarly to the separate hydraulic liquid in FIG. 1b—arrives into the upper region of the main bore 12B above the valve tappet 24. The valve tappet 24 is pressed hereby contrary to the force of a return spring 38 beyond the outlet port 18 downwards, so that its main liquid bore 24A frees the flow path from the feed section 16A and its auxiliary liquid bore 24B frees the inflow of auxiliary liquid from the auxiliary port 22 into the mixing section 16B. After intermixing in the static mixer 20, secured in the valve tappet 24, the mixture of main and auxiliary liquid flows via radial outflow bores 24C out from the valve tappet 24 into the main bore 12B and leaves the dosing module 10 through the outlet port 17 provided at the bottom in the main bore 12B.

For switching over into the bypass position shown in FIG. 3b, the 4/2-way valve 25 associated with the valve tappet 24 is switched such that the main liquid flows through a direct inlet port 40 directly into the bypass section 16C, which opens into the lower region of the main bore 12B, in which the valve tappet 24 is received. Through this impingement from below in the region of the sealing edge 24D, supported by the action of the return spring 38, the valve tappet 24 in the main bore 12B is displaced upwards beyond the outlet port 18, and its circumferential wall beneath the main liquid bore 24A and the auxiliary liquid bore 24B blocks the further inflow of main and auxiliary liquid to the static mixer 20. In this bypass position, the main liquid consequently flows through the direct inlet port 40 and the bypass section 16C without contact with the static mixer 20 directly to the outlet port 18.

In the third embodiment shown in FIGS. 3a and 3b, the diameter of the main bore 12B receiving the valve tappet 24 in the housing 12 is adapted in its upper region to the outer diameter of the valve tappet 24, however in its lower region is widened to the slightly larger outer diameter of the sealing edge 24D. In the transition region between these two diameters, the housing 12 therefore forms a sealing seat for the sealing edge 24D, which improves the sealing in this region.

FIGS. 4a and 4b show a diagrammatic sectional view of a fourth embodiment of the dosing module according to the invention in the dosing position or respectively in the bypass position. With regard to the hydraulic controlling of the valve tappet 24 and the branching of the feed section 16A of the flow duct 16 into a mixing section 16B and a bypass section 16C parallel hereto, this fourth embodiment is similar to the first and second embodiment, wherein, however, the role of the bores 30, 32 is inverted for geometric reasons. A supply of hydraulic fluid through the upper bore 32 brings the valve tappet into the dosing position shown in FIG. 4a, a supply of hydraulic fluid through the lower bore 30 brings it into the bypass position shown in FIG. 4b. In contrast to the third embodiment, no additional direct inlet port 40 is provided.

On the other hand, the fourth embodiment, without regard to the course of the bypass section 16C in the lower region of the housing 12 corresponds to the third embodiment. Here, also, the bypass section 16C therefore opens into the lower region of the main bore 12B, in which the valve tappet 24 is received. The course of the diameter of the main bore 12B is, again, selected such that the housing 12 forms a seal seat for the sealing edge 24D of the valve tappet 24 in the bypass position.

In the embodiments, described above, of the dosing module according to the invention, the static mixer 20 for mixing the main and auxiliary liquid is integrated respectively in a valve tappet 24, which is movable in the housing 12.

In the following embodiments, on the other hand, the static mixer 20 is arranged respectively securely in the housing 12. Instead of a movable valve tappet 24, respectively a different type of directional valve is provided.

Thus, FIGS. 5a and 5b show a diagrammatic sectional view of a fifth embodiment of the dosing module according to the invention in the dosing position or respectively in the bypass position. The static mixer 20 is integrated in a stationary manner in the mixing section 16B of the flow duct. Downstream of the static mixer 20, in the main bore 12B receiving it, a ball cock valve 42 with an L-shaped bore 42 A is rotatably arranged.

In the dosing position shown in FIG. 5a, the rotational position of the ball cock valve 42 is selected such that the outlet port 18 provided in the lower region of the main bore 12B is connected to the mixing section 16B, whereas the downstream end of the bypass section 16C is closed by the ball cock valve 42. The main liquid therefore flows through the inlet port 14 and the feed section 16A into the mixing section 16B, where it is mixed in the static mixer 20 with the auxiliary liquid from the auxiliary port 22.

From there, the mixture flows through the L-shaped bore 42A of the ball cock valve 42 into the outlet port 18.

In order to bring the directional valve into the bypass position shown in FIG. 5b, the ball cock valve 42 is rotated through 90 degrees about an axis orthogonal to the plane of the drawing. This rotation is indicated by an arrow in FIGS. 5a and 5b, and causes the outlet port 18, provided in the lower region of the main bore 12B, to be connected to the bypass section 16C, whereas the mixing section 16B is closed by the ball cock valve 42. Hereby, the static mixer 2 is, as it were, short-circuited, although it can continue to fill up with main and auxiliary liquid, which, however, do not arrive at the outlet port 18. Rather, pure main liquid flows through the bypass section 16C directly to the outlet port 18.

The rotation of the ball cock valve 42 can preferably take place electrically or mechanically via belts and/or linkage and/or pneumatically or respectively hydraulically. The associated control unit, which can be, for example, an actuating drive, should be placed here offset from the ball cock valve 42.

FIG. 5c shows a diagrammatic sectional view of the ball cock valve 42 with a section along the plane A-A in FIG. 5b.

FIGS. 6a and 6b show a diagrammatic sectional view of a sixth embodiment of the dosing module 10 according to the invention in the dosing position or respectively in the bypass position. Again, the static mixer 20 is integrated securely in the mixing section 16B of the flow duct 16.

Similarly to in the third embodiment, the sixth embodiment of the dosing module 10 also comprises an inlet port 14 with downstream feed section 16A and mixing section 16B, in which the static mixer 20 is arranged, and in addition a direct inlet port 40, through which the main liquid can flow directly into a separate bypass section 16C.

The downstream end of the mixing section 16B is separated by a non-return valve from a horizontally-running outlet bore 18B in FIGS. 6a and 6b, in which outlet bore the outlet port 18 is provided. The non-return valve comprises in this embodiment by way of example a ball 44, which is pressed by a spring 46 against a valve seat.

Likewise, the downstream end of the bypass section 16C is separated by a further non-return valve from the outlet bore 18B. In this embodiment, this further non-return valve also comprises a ball 48, which is pressed by a spring 50 against a valve seat.

Similarly to in the third embodiment, the supply of the main liquid to the inlet port 14 or to the direct inlet port 40 is controlled by a 4/2-way valve, which is not illustrated in FIG. 6a and FIG. 6b.

In the dosing position illustrated in FIG. 6a, the main liquid flows through the inlet port 14 into the feed section 16 A, where it meets auxiliary liquid from the auxiliary port 22. The two liquids are subsequently mixed in the static mixer 20, which is securely mounted in the mixing section 16B, and flow past the ball 44 which is raised by the pressure of the mixture, into the outlet bore 18B and through the outlet port 18 from the dosing module 10. The non-return valve with the ball 48 at the end of the pressureless bypass section 16C is closed here owing the impingement by the spring 50.

In the bypass position illustrated in FIG. 6b, the main liquid flows through the direct inlet port 40 directly into the bypass section 16 C. Without contact with the static mixer 20, it flows past the ball 48, which is raised by the pressure of the pure main liquid, into the outlet bore 18B and through the outlet port 18 out from the dosing module 10. The non-return valve with the ball 44 at the end of the pressureless mixing section 16B is closed here owing to the impingement by the spring 46.

FIGS. 7a and 7b show a diagrammatic sectional view of a seventh embodiment of the dosing module 10 according to the invention in the dosing position or respectively in the bypass position. In this embodiment, the directional valve comprises a slide valve 52 with two outer pistons 52A and 52B, which are displaceable in a hydraulically driven manner in a horizontal outlet bore 18B in the figures, in which outlet bore the outlet port 18 is provided. Other types of drive for the slide valve 52 are of course possible, for example a pneumatic and/or electric drive.

In the dosing position shown in FIG. 7a, the left-hand piston 52A frees the connection between the mixing section 16B and the outlet bore 18B, whilst the right-hand piston 52B shuts off the bypass section 16C from the outlet bore 16B, so that only a mixture of main and auxiliary liquid can flow out from the static mixer 20 out of the dosing module 10.

In the bypass position shown in FIG. 7b, on the other hand, the left-hand piston 52A shuts off the connection between the mixing section 16B and the outlet bore 18B, whilst the right-hand piston 52B frees the connection from the bypass section 16C to the outlet bore 18B, so that only the pure main liquid can flow out from the dosing module 10, bypassing the static mixer 20.

The housing 12 comprises, in the outlet bore 18B in the region of the outlet port 18, circumferential projections 18C, which form associated seal seats for the pistons 52A, 52B.

FIGS. 8a and 8b show a diagrammatic sectional view of an eighth embodiment of the dosing module 10 according to the invention in the dosing position or respectively in the bypass position. This embodiment differs from the seventh embodiment explained above in that the slide valve 52, instead of two outer pistons, comprises only one single central piston 52C. In the dosing position shown in FIG. 8a, this central piston 52C closes the outlet bore 18B between the outlet port 18 and the bypass section 16C, whilst the connection is freed from the mixing section 16B to the region of the outlet bore 18B, in which the outlet port 18 lies.

On the other hand, the central piston 52C, in the bypass position of FIG. 8b, closes the outlet bore 18B between the outlet port 18 and the mixing section 16B, whilst the connection from the bypass section 16C to the region of the outlet bore 18B, in which the outlet port 18 lies, is freed.

Also in the eighth embodiment, the housing 12 in the outlet bore 18B in the region of the outlet port 18 comprises circumferential projections 18C, which form associated seal seats for the central piston 52C.

The dosing module 10 according to the invention enables in all embodiments a switching over of the directional valve between the dosing position, in which the main and the auxiliary liquid are mixed in the mixing device of the dosing module 10 and are issued through the outlet port 18, and the bypass position, in which unmixed main liquid is directed, past the mixing device, to the outlet port 18 and therefore can recirculate to the main liquid tank, without having to fear its gradual contamination with auxiliary liquid.

What is claimed is:

1. A dosing module (10) for dosing an auxiliary liquid into a flow of a main liquid, comprising
a housing (12) with an inlet port (14) and an outlet port (18) and with a flow duct (16), formed in between, for the main liquid;
an auxiliary port (22) which is provided in the housing (12) and which serves for the supply of the auxiliary liquid into the flow duct (16);
a mixing device (20) which is provided in a mixing section (16B) of the flow duct and which serves for mixing the main liquid and the auxiliary liquid;
characterized in that the dosing module (10) furthermore comprises:
a bypass section (16C) for conducting the flow of main liquid to the outlet port (18) so as to bypass the mixing device (20); and
a directional valve (24, 25; 42; 44, 48; 52) which is designed to connect the outlet port (18), in a dosing position, to the mixing section (16B) and, in a bypass position, to the bypass section (16C).

2. The dosing module (10) according to claim 1, wherein the bypass section (16C) is formed in the housing (12) or is provided on the outer side of the housing (12), in particular as a pipeline.

3. The dosing module (10) according to claim 1, wherein the mixing device (20) is a static mixer.

4. The dosing module (10) according to claim, wherein the directional valve comprises a valve tappet (24), in which the mixing device (20) is arranged, wherein the valve tappet (24) in the housing (12) is displaceable between a dosing position, in which the flow of main liquid and the auxiliary liquid run through the valve tappet (24), and a bypass position, in which the valve tappet (24) conducts the flow of main liquid into the bypass section (16C) and separates the auxiliary port (22) from the flow duct (16).

5. The dosing module (10) according to claim 4, wherein the valve tappet (24), in the bypass position, closes the auxiliary port (22).

6. The dosing module (10) according to claim 4, wherein the valve tappet (24) is provided with a recirculation groove (34) which, in the bypass position, connects the auxiliary port (22) with an auxiliary liquid return duct (36) provided in the housing (12).

7. The dosing module (10) according to claim 4, wherein the valve tappet (24) is displaceable between the dosing position and the bypass position by a hydraulically and/or pneumatically and/or electrically driven sliding- and/or rotational movement.

8. The dosing module (10) according to claim 7, wherein the valve tappet (24) is designed for hydraulic displacement using the main liquid as hydraulic liquid.

9. The dosing module (10) according to claim 8, further comprising a return spring (38) which acts upon the valve tappet (24) in the direction of the bypass position.

10. The dosing module (10) according to claim 1, further comprising a direct inlet port (40) for the direct letting in of main liquid into the bypass section (16C).

11. The dosing module (10) according to claim 1 wherein the mixing device (20) is integrated in a stationary manner in the mixing section (16B) of the flow duct (16), and that the directional valve comprises a ball cock valve (42), a non-return valve or a slide valve (52), which is provided downstream of the mixing device (20) and is designed, in a dosing position, to conduct the flow of main liquid, intermixed with auxiliary liquid, to the outlet port (18) and, in a bypass position, to conduct the flow of main liquid out from the bypass section (16C) to the outlet port (18).

12. The dosing module (10) according to claim 11, wherein the directional valve comprises respectively a non-return valve associated with the mixing section (16B) or respectively with the bypass section (16C).

13. The dosing module (10) according to claim 12, wherein at least one of the non-return valves comprises a ball (44, 48) with an associated seal seat.

14. The dosing module (10) according to claim 1, wherein the main liquid contains a resin and/or that the auxiliary liquid contains a releasing agent.

15. The dosing module (10) according to claim 1, wherein the main liquid and/or the auxiliary liquid contain different dyes, lacquers and/or glazes.
